(19) United States
(12) Patent Application Publication
(10) Pub. No.: US 2025/0038326 A1
(43) Pub. Date: Jan. 30, 2025

(54) ASSEMBLIES FOR PROTECTING BATTERY PACKS OF A VEHICLE

(71) Applicant: Toyota Motor Engineering & Manufacturing North America, Inc., Plano, TX (US)

(72) Inventors: Kaitlyn A. Cherniuk, Ypsilanti, MI (US); Ryan C. Harris, Saline, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/361,297

(22) Filed: Jul. 28, 2023

(51) Int. Cl. H01M 50/24; H01M 50/204; H01M 50/224; H01M 50/249

(52) U.S. Cl. CPC H01M 50/24; H01M 50/204; H01M 50/224; H01M 50/249

(57) ABSTRACT

Disclosed herein are assemblies for protecting the battery pack of a vehicle. The vehicle includes a pair of side frame members. A battery pack is located between the side frame members. A battery protection plate has an upper surface, an opposite lower surface, a plurality of mounting bosses, and a plurality of openings. The plurality of mounting bosses are coupled to the battery protection plate to the pair of side frame members, and the plurality of openings extend between the upper surface and the opposite lower surface. The plurality of openings are configured to expose at least a portion of the battery pack to an exterior atmosphere so as to allow fluid to drain through the plurality of openings.

### TECHNICAL FIELD

The present specification generally relates to assemblies for protecting battery packs of a vehicle and, more specifically, assemblies for protecting battery packs of a vehicle which reduce weight and permit water or other fluids to drain from beneath the battery pack and towards the ground.

### BACKGROUND

As background, vehicles, such as electric or hybrid vehicles, may feature large battery packs to power the drive motors of the vehicle. The battery pack may be placed underneath the vehicle in the area of the vehicle where internal-combustion vehicles may have exhaust pipes, transmissions, fuel tanks, or other components. The battery packs may be susceptible to damage caused by road debris or impact, so vehicles may have a protection plates in order to protect the battery. Current battery pack protectors may be solid plates, which can be heavy and may cause water or other fluids to be retained between the solid plate and the battery. Heavier battery pack protectors can reduce the range and performance of electric vehicles, and the retained water or other fluids may cause corrosion to the battery protection plate or other parts of the vehicle.

Accordingly, a need exists for improved battery pack protection plates that provide a reduction in weight and permit water or other fluids to drain from beneath the battery pack and towards the ground.

### SUMMARY

In accordance with one embodiment, an assembly for protecting the battery pack of a vehicle is disclosed. The vehicle includes a pair of side frame members. A battery pack is located between the side frame members. A battery protection plate has an upper surface, an opposite lower surface, a plurality of mounting bosses, and a plurality of openings. The plurality of mounting bosses are coupled to the battery protection plate to the pair of side frame members, and the plurality of openings extend between the upper surface and the opposite lower surface. The plurality of openings are configured to expose at least a portion of the battery pack to an exterior atmosphere so as to allow fluid to drain through the plurality of openings. These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a top view of a battery protection plate with a plurality of mounting bosses and a plurality of openings of different shapes and sizes, according to one or more embodiments shown and described herein;

FIG. 2 schematically depicts a partial cross-sectional view of a battery protection plate taken along line II-II of FIG. 1, according to one or more embodiments shown and described herein;

FIG. 3 schematically depicts a top view of a battery protection plate with a plurality of mounting bosses and a plurality of openings, according to one or more embodiments shown and described herein; and

FIG. 4 schematically depicts a partial cross-sectional view of a battery protection plate taken along line IV-IV of FIG. 3, according to one or more embodiments shown and described herein.

### DETAILED DESCRIPTION

Embodiments described herein are directed to a battery protection plate that includes one or more mounting bosses for attaching the protection plate to a vehicle and one or more openings to reduce the weight of the protection plate and allow water and other liquids to drain away from the protection plate.

The battery protection plate includes one or more openings, one or more dividing portions, one or more mounting bosses, and one or more edge portions. The openings may be formed between the dividing portions and may be surrounded on the perimeter by the edge portions. The openings may reduce the weight of the battery protection plate compared to a solid plate. Further, the openings may allow water and other fluids to drain away from the battery protection plate and towards the ground beneath the openings. The edge portions of the battery protection plate may feature drainage channels. The drainage channels may be oriented towards the openings to enhance the ability of the battery protection plate to drain water and other liquids. Various embodiments of the assembly and the operation of the assembly are described in more detail herein. Whenever possible, the same reference numerals will be used throughout the drawings to refer to the same or like parts.

As used herein, the term “vehicle longitudinal direction” refers to the forward-rearward direction of the vehicle (i.e., in the +/− vehicle X-direction as depicted). The term “vehicle lateral direction” refers to the cross-vehicle direction of the vehicle (i.e., in the +/− vehicle Z-direction as depicted), and is transverse to the vehicle longitudinal direction. The term “vehicle vertical direction” refers to the upward-downward direction of the vehicle (i.e., in the +/− vehicle Y-direction as depicted). Further, the terms “upward,” “downward,” “rearward,” and “forward” are used to describe the relative positioning of various components of the vehicle relative to one another. Because the vehicle structures may be generally symmetrical about the vehicle centerline, the terms “upward,” “downward,” “rearward,” and “forward” may be switched when evaluating components positioned along opposite sides of the vehicle. Further, while certain components of the vehicle are described as extending in one of the identified directions or oriented toward one of the identified directions, it should be understood that these components extend or are oriented in at least these recited directions.

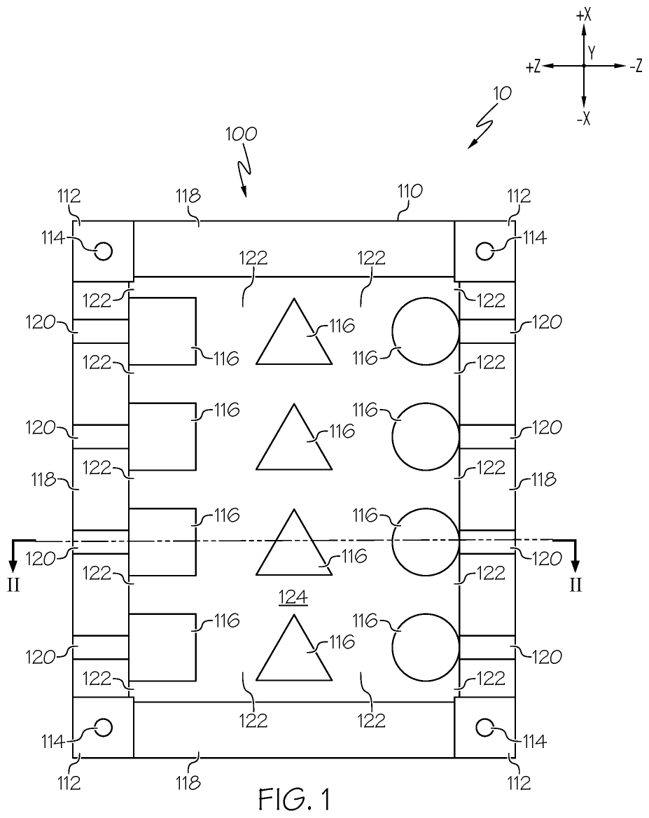

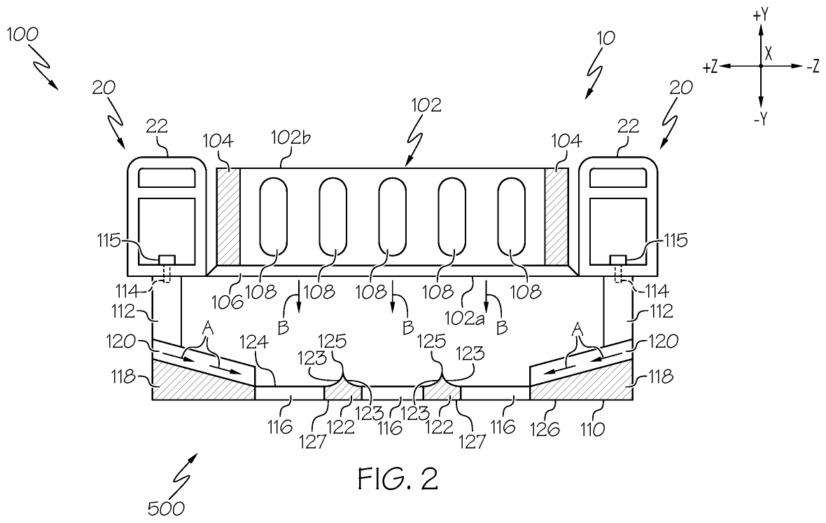

Referring now to FIGS. 1 and 2, a battery protection assembly 100 having a battery protection plate 110 coupled to a vehicle 10 to protect a battery pack 102 from damage due to impact or corrosion is illustrated according to one or more embodiments described herein. The vehicle 10 may be an electric vehicle, a hybrid vehicle, or any other type of vehicle that utilizes the battery pack 102. The vehicle 10 has a vehicle frame 20. The vehicle frame 20 has a pair of side frame members 22 which extend in the vehicle longitudinal direction. While the pair of side frame members 22 are illustrated as having a substantially rectangular cross-section, it should be understood that the side frame members 22 may have any suitable cross-section, including but not limited to a circle or an oval.

The battery pack 102 is located between the pair of side frame members 22. The battery pack 102 may be placed in an area of the vehicle 10 where exhaust pipes, transmissions, fuel tanks, and/or other components are conventionally mounted on internal combustion engine vehicles. However, it should be understood that the battery pack 102 may be mounted in any suitable location on the vehicle 10. The battery pack 102 may include a pair of opposing side frame members 104 and a lower frame member 106. The battery pack 102 may be coupled to the vehicle 10 via the pair of side frame members 104 and/or the lower frame member 106. The battery pack 102 may have a plurality of battery cells 108 placed between the pair of opposing side frame members 104 and the lower frame member 106. In some embodiments, the lower frame member 106 may be formed of a cooling plate for the battery pack 102.

The battery protection assembly 100 includes a battery protection plate 110 and a plurality of mounting bosses 112. The mounting bosses 112 may include mounting boss holes 114. The mounting boss holes 114 may be for example threaded holes. The battery protection assembly 100 may be coupled to the side frame members 22 via fasteners 115 which may attach through the side frame members 22 into the mounting boss holes 114. As a non-limiting example, fasteners 115 may be bolts, screws, stud-and-nuts, or any other suitable device for coupling the side frame members 22 to the mounting bosses 112 of the battery protection assembly 100. However, it should be understood that the mounting bosses 112 may have any other suitable fastening mechanism for attaching the battery protection assembly 100 to the vehicle 10, such as geometric fastening or being welded directly to the vehicle 10. While four mounting bosses 112 are illustrated, it should be understood that any greater or fewer number of mounting bosses 112 may be used, including but not limited to two mounting bosses 112, three mounting bosses 112, five mounting bosses 112, ten mounting bosses 112, or any other suitable number of mounting bosses 112.

The battery protection plate 110 may be constructed of any suitable material, including but not limited to steel, aluminum, and/or composite materials such as carbon fiber. The battery protection plate 110 may include an upper surface 124 and an opposite lower surface 126. The upper surface 124 may be directed to face the battery pack 102 and/or vehicle 10 when the battery protection plate 110 is mounted to the vehicle 10. As illustrated, the battery protection plate 110 is substantially rectangular, but it should be understood that in embodiments the battery protection plate 110 may be any suitable shape.

The battery protection plate 110 includes a plurality of openings 116 that extend between the upper surface 124 and the lower surface 126. The openings 116 are areas of the battery protection plate 110 without any material present. The openings 116 may be divided by a plurality of dividing portions 122 in both the vehicle lateral direction and the vehicle longitudinal direction. The openings 116 may also be referred to as slots, vents, cutouts, or any other feature which may remove material from the battery protection plate 110. The openings 116 may be any suitable shape. As a non-limiting example, the openings 116 may be a rectangle, a circle, a triangle, an oval, a grate pattern, or any other suitable shape.

The openings 116 may be any suitable size. For example, the openings 116 may be sized so as to not allow a piece of debris of a particular size to pass through the openings 116. The debris could be for example a tire, an animal, or any other object commonly encountered on a roadway. While the openings 116 are shown as being substantially equal size to one another, it should be understood that some embodiments of the battery protection plate 110 may have openings of various sizes.

In some embodiments, the battery protection plate 110 may be constructed of solid sheet metal such that the openings 116 may be stamped out from the solid sheet metal and the dividing portions 122 are the material remaining between the openings after the sheet metal has been stamped.

The openings 116 may reduce the weight of the battery protection plate 110 compared to a solid plate. By reducing the weight of the battery protection plate 110, the range and/or performance of the vehicle may be enhanced. The openings 116 are configured to expose at least a portion of a lower surface 102a of the lower frame member 106 of the battery pack 102 to an exterior atmosphere 500 of the vehicle 10 such that fluids be drained to the ground, such as the roadway the vehicle is travelling upon, as described in greater detail below. In some embodiments, the lower surface 102a is formed by the bottom surface of the lower frame member 106.

In embodiments, the openings 116 may be evenly spaced from one another by the dividing portions 122 such that a distance between adjacent openings 116 is equal.

Referring now to FIG. 2, a partial cross-sectional view of the battery protection plate 110 and the battery pack 102 is illustrated according to one or more embodiments described herein. The lower surface 126 may be directed towards outside ground, such that the openings 116 may be open to the exterior atmosphere 500 of the vehicle 10 and face the ground. The battery pack 102 may have a lower surface 102a and an upper surface 102b. The lower surface 102a of the battery pack 102 may be directed towards the upper surface 124 of the battery protection plate 110.

As illustrated, the battery protection plate 110 is shown with a substantially flat lower surface 126. However, it should be understood that the battery protection plate 110 may have any suitable shape, such as a convex shape relative to the lower surface 102a of the battery pack 102. Further, the battery protection plate 110 may have an angled shape such that the lower surface 126 has a shallow “V” shape relative to the lower surface 102a of the battery pack 102. Both the convex shape and the shallow “V” shape may enhance the ability of the battery protection plate 110 to drain water or other liquid towards the ground compared to a battery protection plate with a flat lower surface 126.

The openings 116 may allow for water or other fluids to drain from beneath the battery pack 102, such as when the vehicle is driven in the rain or is washed. The battery protection plate 110 may include a plurality of edge portions 118. The edge portions 118 may surround the openings 116. The edge portions 118 may include one or more drainage channels 120. The drainage channels 120 may be positioned toward the openings 116 so as to enhance the ability of the battery protection plate 110 to drain water or other fluids away from the battery pack 102. The drainage channels 120 may be sloped downwards towards the openings 116 so as to further enhance the ability of the battery protection plate 110 to drain water or other fluids away from the battery pack 102. The flow of fluid along the drainage channels 120 as indicated by arrows “A” and through the plurality of openings 116 to the exterior atmosphere 500 of the vehicle 10.

In some environments, condensation may form on the lower surface 102a of the battery pack 102. The openings 116 may allow for the condensation to drain away from the battery pack 102. The flow of fluid from the lower surface 102a of the battery pack 102 is indicated by the arrows “B” and through the plurality of openings 116 to the exterior atmosphere 500 of the vehicle 10.

The edge portions 118 and drainage channel 120 may have other suitable shapes to allow water or other fluids to drain towards the openings 116, such as a parabolic shape. Further, it should be understood that the edge portion 118 and the drainage channel 120 may be parallel to the openings 116, or the edge portion 118 and drainage channel 120 may be sloped away from the openings 116. In other embodiments not illustrated, there may be no drainage channels 120.

Each of the dividing portions 122 may have an upper surface 123 and a lower surface 127. The upper surface 123 of the dividing portions 122 may have a sloped shape with an apex 125 oriented towards the plurality of openings 116 so as to allow water or other fluid to drain towards the openings 116. In other embodiments, the upper surface 123 of the dividing portions 122 may have a parabolic shape towards the opening 116. In yet other embodiments, the upper surface 123 of the dividing portions 122 may have a flat shape such that the upper surface 123 of the dividing portion 122 top is parallel to the openings 116. The dividing portions 122 may also have any other suitable shape. While the upper surface 123 of the dividing portions 122 are illustrated as each having the same shape, it should be understood that in embodiments the upper surface 123 of one of the dividing portions 122 may have one shape while the upper surface 123 of another dividing portion 122 may have another shape.

The mounting bosses 112 may space the upper surface 124 of the battery protection plate 110 from the lower surface 102a of the battery pack 102. While the mounting bosses 112 are illustrated as being substantially the same height, it should be understood that the mounting bosses 112 may be different heights. For example, the mounting bosses 112 towards the front of the vehicle may be shorter than the mounting bosses 112 towards the rear of the vehicle such that the battery protection plate 110 is sloped from front to back. In other embodiments, the height of the mounting bosses towards the rear of the vehicle may be shorter than the height of the mounting bosses towards the front of the vehicle, such that the battery protection plate 110 is sloped back to front.

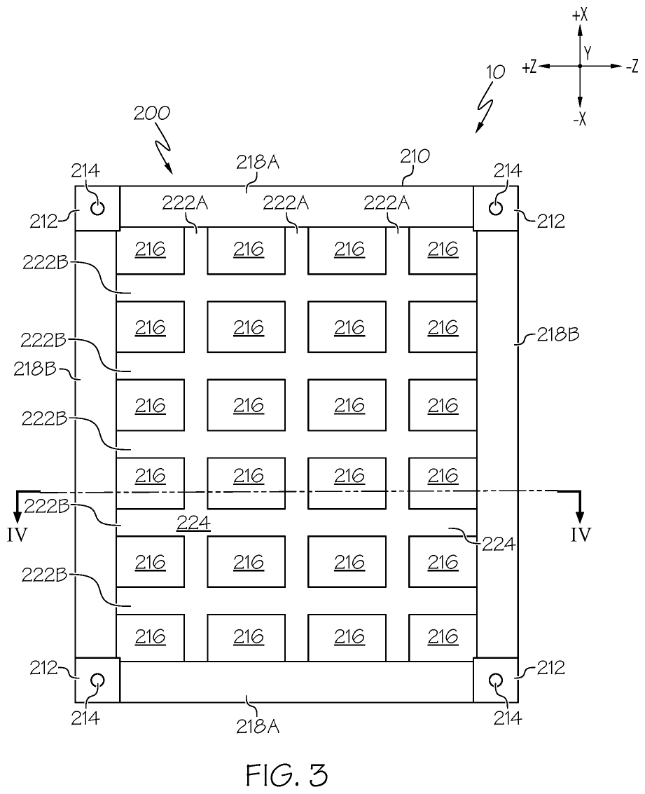

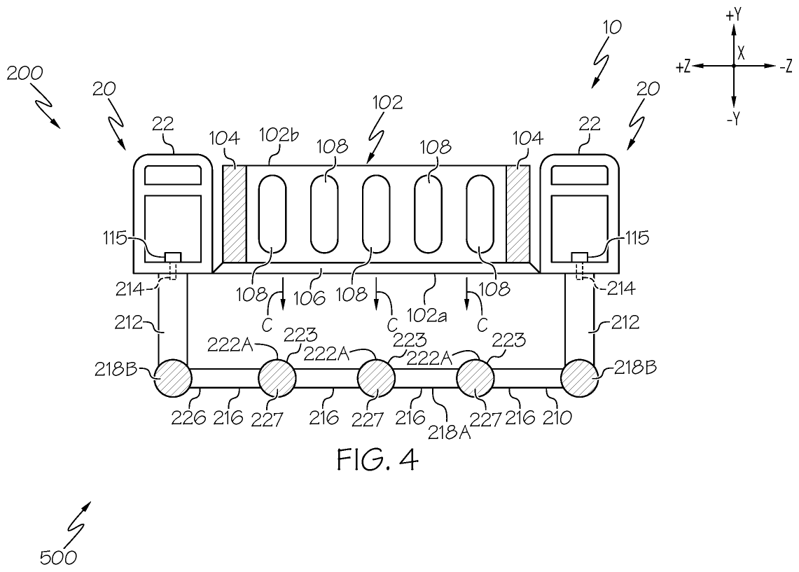

Referring now to FIGS. 3 and 4, a battery protection assembly 200 having a battery protection plate 210 coupled to the vehicle 10 to protect the battery pack 102 from damage due to impact or corrosion is illustrated according to one or more embodiments described herein. The battery protection assembly 200 may have similar features to those of battery protection assembly 100. Edge portions 218a may run in the vehicle lateral direction and edge portions 218b may run in the vehicle longitudinal direction. Dividing portions 222a may run between edge portions 218a, and dividing portions 222b may run between edge portions 218b. The dividing portions 222a and 222b and the edge portions 218a and 218b may be constructed out of tubular members, such that the openings 216 may be formed in the space between the tubular members. The tubular members may be fastened together with any suitable fastening mechanism, such as with threaded fasteners or welding. As illustrated, the dividing portions 222a and 222b and the edge portions 218a and 218b are arranged in a grid, however it should be understood that the dividing portions 222a and 222b and the edge portions 218a and 218b may be arranged in any suitable layout, such as dividing portions 222a and 222b being arranged in an “X” layout between the edge portions 218a and 218b, a crisscross layout between the edge portions 218a and 218b, or any other suitable layout.

Referring now to FIG. 4, a cross-sectional view of the battery protection assembly 200 is illustrated according to one or more embodiments described herein. The dividing portions 222a and 222b may be round tubular members. The dividing portions 222a and 222b may have an upper surface 223 and a lower surface 227. The upper surface 223 may be the top semi-circle of the dividing portions 222a and 222b, and the lower surface 227 may be the bottom semi-circle of the dividing portions 222a and 222b. The rounded shape of the upper surface 223 may enhance the ability of the battery protection plate 210 to drain water or other fluids towards the plurality of openings 216. In embodiments, the dividing portions 222a and 222b may have other-shaped tubular members, such as square tubes, hexagonal tubes, oval tubes, or any other suitable shape. As illustrated, the dividing portions 222a and 222b may have substantially similar diameters, but it should be understood that in embodiments the dividing portions 222a and 222b may have different diameters, such that some dividing portions 222a and 222b may have larger or smaller diameters than other dividing portions 222a and 222b. As illustrated, the dividing portions 222a and 222b are substantially equidistant from the lower surface 102a of the battery pack 102, but it should be understood that in embodiments, one or more dividing portions 122 may be placed a larger or smaller distance apart from the lower surface 102a of the battery pack 102. As a non-limiting example, the middle dividing portion 222a may be spaced a greater distance from the lower surface 102a of the battery pack 102 than the outer dividing portions 222a.

In some environments, condensation may form on the lower surface 102a of the battery pack 102. The openings 216 may allow for condensation to drain away from the battery pack 102 to the exterior atmosphere 500 of the vehicle 10. The flow of fluid from the lower surface 102a of the battery pack 102 is indicated by the arrows “C.”

From the above, it is to be appreciated that defined herein is an improved battery protection assembly which is lighter in weight and is able to allow water or other fluids to drain from beneath the battery pack and towards the ground.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle comprising:
a vehicle frame having a pair of side frame members;
a battery pack located between the pair of side frame members; and
a battery protection plate having an upper surface, an opposite lower surface, a plurality of mounting bosses, and a plurality of openings, the plurality of mounting bosses are coupled to the battery protection plate to the pair of side frame members, and the plurality of openings extend between the upper surface and the opposite lower surface, the plurality of openings are configured to expose at least a portion of the battery pack to an exterior atmosphere so as to allow fluid to drain through the plurality of openings.

2. The vehicle of claim 1, wherein the plurality of openings of the battery protection plate are evenly spaced.

3. The vehicle of claim 1, wherein the plurality of openings are formed having a same shape.

4. The vehicle of claim 1, wherein the battery pack comprises a lower frame member, a pair of side frame members, and a plurality of battery cells.

5. The vehicle of claim 1, wherein the battery protection plate further comprises a plurality of drainage channels.

6. The vehicle of claim 5, wherein the plurality of drainage channels are directed towards the plurality of openings.

7. The vehicle of claim 1, wherein the battery protection plate comprises stamped sheet metal.

8. The vehicle of claim 1, wherein the battery protection plate comprises a plurality of tubular members.

9. The vehicle of claim 1, wherein the upper surface of the battery pack protection plate is spaced apart from a bottom surface of the battery pack.

10. The vehicle of claim 1, wherein the plurality of openings are formed between a plurality of side frame members, the plurality of side frame members having a sloped cross-sectional shape with an apex.
